(19) United States
(12) Patent Application Publication
(10) Pub. No.: US 2024/0310552 A1
(43) Pub. Date: Sep. 19, 2024

(54) DENSITY DETERMINATION METHOD, APPARATUS AND ELECTRONIC DEVICE

(71) Applicant: THE INSTITUTE OF GEOLOGY AND GEOPHYSICS, CHINESE ACADEMY OF SCIENCES, Beijing (CN)

(72) Inventor: Zhenli WANG, Beijing (CN)

(21) Appl. No.: 18/575,639

(22) PCT Filed: Jul. 4, 2022
(86) PCT No.: PCT/CN2022/103726

§ 371 Date: Dec. 29, 2023

(30) Foreign Application Priority Data
Jul. 5, 2021 (CN) 202110758646.6

(51) Int. Cl. G01V 7/00; G01N 9/00

(52) U.S. Cl. CPC G01V 7/00; G01N 9/00

(57) ABSTRACT

Disclosed are density determination method, apparatuses, and electronic device, applied in geophysical exploration, comprising: acquiring Bouguer gravity anomalies at measurement points for a target body to be measured; determining a Bouguer gravity anomaly of the target body for each measurement point as a first anomaly based on the Bouguer gravity anomalies at the measurement points, and determining a Bouguer gravity anomaly of a reference body corresponding to the target body to be measured at the measurement point as a second anomaly at the measurement point, based on the Bouguer gravity anomalies at the measurement points; calculating a difference between the first anomaly and the second anomaly at the measurement point as a local gravity anomaly; and performing density inversion on the target body to be measured to obtain density distribution in transverse cross-section of the target body, thereby obtaining the density of the target body more accurately.

### CROSS-REFERENCE TO RELATED APPLICATIONS

The present application claims the priority of the Chinese patent application No. 202110758646.6, filed with the China National Intellectual Property Administration on Jul. 5, 2021, entitled “Density Determination Method, Apparatus, and Electronic Device”, the entire disclosure of which is incorporated herein by reference in its entirety.

### FIELD OF THE INVENTION

The present application relates to the field of geophysical exploration and, in particular, to a density determination method, apparatuses and electronic device.

### BACKGROUND ART

In gravity detection, it is often necessary to invert density anomalies based on gravity anomalies in order to recognize the spread of underground objects, i.e., the distribution of underground objects. Density inversion is a method to invert the density change of underground target body which may be a geological body such as an ore, an oil field, or a cave, based on gravity anomaly.

In the related technology, in order to invert the density of a target body, it is necessary to establish a density prediction model for the target body based on prior knowledge in advance to predict the possible change frequency interval of the local gravity anomaly of the target body. A plurality of measurement points is set up for the target body, and gravity data at each measurement point is measured using gravity measurement equipment. The gravity data are processed for latitude correction, terrain correction, etc., to obtain a Bouguer gravity anomaly at each measurement point. Then, low-frequency anomalies with lower change frequencies in the Bouguer gravity anomalies are eliminated, and the remaining high-frequency anomalies with higher change frequencies are used as local gravity anomalies.

Further, the obtained local gravity anomalies are divided in multiple scales, i.e., divided according to different change frequencies, to obtain local gravity anomalies corresponding to multiple change frequency intervals. The local gravity anomaly that matches the possible change frequency region of the predicted local gravity anomaly of the target body is used as the local gravity anomaly of the target body. The density of the target body is obtained by performing density inversion based on the local gravity anomaly of the target body.

The high-frequency anomalies in the Bouguer gravity anomalies are directly used as local gravity anomalies in the related art. However, high-frequency anomalies are not necessarily local gravity anomalies. Therefore, the local gravity anomalies obtained by the related technology are inaccurate. Meanwhile, the local gravity anomaly of the target body obtained through multi-scale division depends on whether the density prediction model can accurately predict the target body, and it is often difficult for the density prediction model to accurately predict the target body. For the above reasons, the local gravity anomaly of the target body obtained by the related technology is inaccurate, and so is the density distribution of the target body obtained through density inversion of the local gravity anomaly of the target body.

### SUMMARY OF THE INVENTION

It is an object of embodiments of the present application to provide a density determination method, apparatus, and electronic device for more accurately obtaining the density of a target body. The specific technical solution is as follows.

In a first aspect, an embodiment of the present application provides a density determination method comprising steps of: acquiring Bouguer gravity anomalies at a plurality of measurement points set for a target body to be measured, wherein the target body to be measured is a geological body at a specified depth, and a first distance between adjacent measurement points among the plurality of measurement points and the specified depth satisfy a preset condition; determining, for each measurement point, a Bouguer gravity anomaly of the target body to be measured at the measurement point as a first anomaly at the measurement point, based on the Bouguer gravity anomalies at the plurality of measurement points, and determining a Bouguer gravity anomaly of a reference body corresponding to the target body to be measured at the measurement point as a second anomaly at the measurement point, based on the Bouguer gravity anomalies at the plurality of measurement points, wherein the reference body is a geological body with a depth greater than the specified depth; calculating, for each measurement point, a difference between the first anomaly and the second anomaly at the measurement point as a local gravity anomaly of the target body to be measured at the measurement point; and performing, based on the local gravity anomaly of the target body to be measured at each measurement point, density inversion on the target body to be measured to obtain a density distribution in a transverse cross-section of the target body to be measured.

In an embodiment of the present application, the step of determining a Bouguer gravity anomaly of the target body to be measured at the measurement point as a first anomaly at the measurement point based on the Bouguer gravity anomalies at the plurality of measurement points comprises: determining a first target region corresponding to the measurement point, wherein the first target region is a region centered on the measurement point and containing a first preset number of first measurement points which are measurement points other than the measurement point; and determining the Bouguer gravity anomaly of the target body to be measured at the measurement point as the first anomaly at the measurement point using a best approximation, based on Bouguer gravity anomalies at the first measurement points within the first target region.

In an embodiment of the present application, the step of determining the Bouguer gravity anomaly of the target body to be measured at the measurement point as the first anomaly at the measurement point using a best approximation based on Bouguer gravity anomalies at the first measurement points within the first target region comprises: obtaining a fitted surface function as a Bouguer gravity anomaly function of the target body to be measured at the measurement point using surface fitting to perform the best approximation, based on the Bouguer gravity anomaly at each of the first measurement points and coordinates of each of the first measurement points within the first target region; and substituting the coordinates of the measurement point into the Bouguer gravity anomaly function of the target body to be measured to obtain the Bouguer gravity anomaly of the target body to be measured at the measurement point as the first anomaly at the measurement point.

In an embodiment of the present application, the step of determining a Bouguer gravity anomaly of a reference body corresponding to the target body to be measured at the measurement point as a second anomaly at the measurement point based on the Bouguer gravity anomalies at the plurality of measurement points comprises: determining a second target region corresponding to the measurement point, wherein the second target region is a region centered on the measurement point and containing a second preset number of second measurement points, a distance between the second measurement point and the measurement point is greater than or equal to twice the first distance, and a distance between adjacent second measurement points is twice the first distance; and determining the Bouguer gravity anomaly of the reference body corresponding to the target body to be measured at the measurement point as the second anomaly at the measurement point using a best approximation, based on Bouguer gravity anomalies at the second measurement points within the second target region.

In an embodiment of the present application, the step of determining the Bouguer gravity anomaly of the reference body corresponding to the target body to be measured at the measurement point as the second anomaly at the measurement point using a best approximation based on Bouguer gravity anomalies at the second measurement points within the second target region comprises: obtaining a fitted surface function as a Bouguer gravity anomaly function of the reference body corresponding to the target body to be measured at the measurement point using surface fitting to perform the best approximation, based on the Bouguer gravity anomaly at each of the second measurement points and coordinates of each of the second measurement points within the second target region; and substituting the coordinates of the measurement point into the Bouguer gravity anomaly function of the reference body to obtain the Bouguer gravity anomaly of the reference body at the measurement point as the second anomaly at the measurement point.

In an embodiment of the present application, the preset condition is:

$$Δ X \leq \frac{h}{a}$$

wherein ΔX is the distance, h is the specified depth, and a is a preset parameter.

In an embodiment of the present application, the step of performing, based on the local gravity anomaly of the target body to be measured at each measurement point, density inversion on the target body to be measured to obtain a density distribution in a transverse cross-section of the target body to be measured comprises: substituting the local gravity anomaly of the target body to be measured at each measurement point into a layer density inversion formula to obtain the density distribution in the transverse cross-section of the target body to be measured, wherein the layer density inversion formula is a transform formula of a density inversion formula in the case of a constant density in a longitudinal cross-section of the target body to be measured.

In an embodiment of the present application, the method further comprises a step of performing a gradient calculation about the density on the target body to be measured based on the density distribution of the target body to be measured, and determining varying boundaries of target bodies of different densities within the target body to be measured based on a result of the gradient calculation.

In a second aspect, embodiments of the present application provide a density determination apparatus comprising: a Bouguer gravity anomaly acquisition module configured to acquire Bouguer gravity anomalies at a plurality of measurement points set for a target body to be measured, wherein the target body to be measured is a geological body at a specified depth, and a first distance between adjacent measurement points among the plurality of measurement points and the specified depth satisfy a preset condition; a regional gravity anomaly acquisition module configured to determine, for each measurement point, a Bouguer gravity anomaly of the target body to be measured at the measurement point as a first anomaly at the measurement point, based on the Bouguer gravity anomalies at the plurality of measurement points, and to determine a Bouguer gravity anomaly of a reference body corresponding to the target body to be measured at the measurement point as a second anomaly at the measurement point, based on the Bouguer gravity anomalies at the plurality of measurement points, wherein the reference body is a geological body with a depth greater than the specified depth; a local gravity anomaly determination module configured to calculate, for each measurement point, a difference between the first anomaly and the second anomaly at the measurement point as a local gravity anomaly of the target body to be measured at the measurement point; and a density inversion module configured to perform, based on the local gravity anomaly of the target body to be measured at each measurement point, density inversion on the target body to be measured to obtain a density distribution in a transverse cross-section of the target body to be measured.

In an embodiment of the present application, the regional gravity anomaly acquisition module comprises:
a first region determination sub-module configured to determine a first target region corresponding to the measurement point, wherein the first target region is a region centered on the measurement point and containing a first preset number of first measurement points which are measurement points other than the measurement point; and a first anomaly determination sub-module configured to determine the Bouguer gravity anomaly of the target body to be measured at the measurement point as the first anomaly at the measurement point using a best approximation, based on Bouguer gravity anomalies at the first measurement points within the first target region.

In an embodiment of the present application, the first anomaly determination sub-module is configured to obtain a fitted surface function as a Bouguer gravity anomaly function of the target body to be measured at the measurement point using surface fitting to perform the best approximation, based on the Bouguer gravity anomaly at each of the first measurement points and coordinates of each of the first measurement points within the first target region; and to substitute the coordinates of the measurement point into the Bouguer gravity anomaly function of the target body to be measured to obtain the Bouguer gravity anomaly of the target body to be measured at the measurement point as the first anomaly at the measurement point.

In an embodiment of the present application, the regional gravity anomaly acquisition module comprises: a second region determination sub-module configured to determine a second target region corresponding to the measurement point, wherein the second target region is a region centered on the measurement point and containing a second preset number of second measurement points, a distance between the second measurement point and the measurement point is greater than or equal to twice the first distance, and a distance between adjacent second measurement points is twice the first distance; and a second anomaly determination sub-module configured to determine the Bouguer gravity anomaly of the reference body corresponding to the target body to be measured at the measurement point as the second anomaly at the measurement point using a best approximation, based on Bouguer gravity anomalies at the second measurement points within the second target region.

In an embodiment of the present application, the second anomaly determination sub-module is configured to obtain a fitted surface function as a Bouguer gravity anomaly function of the reference body corresponding to the target body to be measured at the measurement point using surface fitting to perform the best approximation, based on the Bouguer gravity anomaly at each of the second measurement points and coordinates of each of the second measurement points within the second target region; and to substitute the coordinates of the measurement point into the Bouguer gravity anomaly function of the reference body to obtain the Bouguer gravity anomaly of the reference body at the measurement point as the second anomaly at the measurement point. Optionally, the preset condition is:

$$Δ X \leq \frac{h}{a}$$

wherein ΔX is the distance, h is the specified depth, and a is a preset parameter.

In an embodiment of the present application, the density inversion module is configured to substitute the local gravity anomaly of the target body to be measured at each measurement point into a layer density inversion formula to obtain the density distribution in the transverse cross-section of the target body to be measured, wherein the layer density inversion formula is a transform formula of a density inversion formula in the case of a constant density in a longitudinal cross-section of the target body to be measured.

In an embodiment of the present application, the apparatus further comprises a boundary determination module configured to perform a gradient calculation on the density of a target body to be measured based on the density distribution of the target body to be measured, and to determine varying boundaries of target bodies of different densities within the target body to be measured based on a result of the gradient calculation.

In a third aspect, an embodiment of the present application provides an electronic device comprising a processor, a communication interface, a memory, and a communication bus, wherein the processor, the communication interface, and the memory communicate with each other via the communication bus; the memory is configured to store a computer program; and the processor is configured to implement any method described in the first aspect in the execution of the program in the memory.

In a fourth aspect, an embodiment of the present application provides a computer-readable storage medium storing a computer program, and when the computer program is executed by a processor, any method described in the first aspect is implemented.

Beneficial effects of embodiments of the present application are as follows.

In the density determination method provided in embodiments of the present application, after obtaining the Bouguer gravity anomalies at a plurality of measurement points, for each measurement point, the Bouguer gravity anomaly of the target body to be measured at the measurement point and the Bouguer gravity anomaly of the reference body corresponding to the target body to be measured can be determined based on the Bouguer gravity anomalies at the plurality of measurement points. Since the Bouguer gravity anomaly of the target body to be measured is formed by superimposing the local gravity anomaly of the target body to be measured and the Bouguer gravity anomaly at a deeper location, and the Bouguer gravity anomaly at the deeper location is equivalent to the Bouguer gravity anomaly of the reference body, an accurate local gravity anomaly of the target body to be measured can be obtained by calculating the difference between the first anomaly and the second anomaly. Therefore, by performing density inversion on the target body to be measured based on the local gravity anomaly of the target body to be measured, an accurate density distribution of the target body to be measured can be obtained. It can be seen that compared with the related art, the present solution can obtain the density of the target body more accurately.

Of course, implementation of any of the products or methods in the present application does not necessarily require that all of the above advantages be achieved at the same time

### BRIEF DESCRIPTION OF THE DRAWINGS

In order to explain the embodiments of the present invention and the technical solutions in the prior art more clearly, the drawings used in the embodiments and the prior art will be briefly described hereinafter. Apparently, the drawings are only embodiments of the present application. For those ordinary skilled in the art, other drawings can be obtained based on these drawings without creative labor.

FIG. 1 is a flowchart of a density determination method provided by an embodiment of the present application.

FIG. 2 is a schematic diagram of a boundary of a measurement region provided by an embodiment of the present application.

FIG. 3a is a Bouguer gravity anomaly diagram obtained by measuring with a distance of 80 meters in the present application.

FIG. 3b is a Bouguer gravity anomaly diagram obtained by measuring with a distance of 40 meters in the present application.

FIG. 3c is a Bouguer gravity anomaly diagram obtained by measuring with a distance of 160 meters in the present application.

FIG. 4 is another flowchart of a density determination method provided by an embodiment of the present application.

FIG. 5 is a schematic diagram of a structure of a density determination apparatus provided by an embodiment of the present application.

FIG. 6 is a schematic diagram of a structure of an electronic device provided by an embodiment of the present application.

### DETAILED DESCRIPTION OF THE INVENTION

In order to make the objects, technical solutions, and advantages of the present application more clearly understood, the present application is hereinafter described in detail with reference to the drawings and embodiments. Obviously, only some, but not all, of the embodiments of the present application are described. All other embodiments obtained by a person skilled in the art based on the embodiments of the present application without creative labor fall within the scope of protection of the present application.

In order to more accurately obtain the density of a target body, embodiments of the present application provide a density determination method, apparatus, and electronic device.

The terminology involved in the embodiments of the present application is first explained below.

Bouguer Gravity Anomaly: The gravity field data after removing the effects of solid tides (deformation of the earth caused by the sun and moon), latitude and longitude, elevation, and intermediate density (density between the measurement plane and the datum).

Regional Gravity Anomaly: The gravity anomaly caused by the density anomaly of the geological body in a deep and wide range of region that is buried deep and has a wide distribution. The characteristics of the regional gravity anomaly are is characterized by wide distribution and small gravity change gradient (slow change frequency). The regional gravity anomaly is important data for the study of regional geological structures and the division of geotectonic units. It should be noted that the term “region” does not have an absolute size concept. For example, in order to search for oil reservoir structures, the gravity anomaly caused by the entire sedimentary basin can be called a regional gravity anomaly; if oil and gas exploration is carried out directly on oil reservoir structures, the gravity anomaly caused by oil reservoir structures rather than that caused by oil and gas layers is a regional gravity anomaly.

Local Gravity Anomalies: The gravity anomaly caused by the density anomaly of the geological body in a shallow region, also known as the residual gravity anomaly, or local Bugge anomaly, etc., which represents the change in the vertical component of gravity caused by the uneven density distribution of the underground geological body. The local gravity anomaly is characterized by large gravity change gradient (fast change frequency).

It should be noted that in the embodiments of the present application, the Bouguer gravity anomaly is a superposition of the local gravity anomaly and the regional gravity anomaly.

In the related technology, in order to invert the density of the target body, it is necessary to establish a density prediction model for the target body based on prior knowledge in advance to predict the possible change frequency interval of the local gravity anomaly of the target body; then the gravity measurement equipment is used to measure the gravity data at each measurement point set for the target body, and the process for latitudinal correction and topographic correction is performed on the gravity data to obtain the Bouguer gravity anomaly at each measurement points. Then, the low-frequency anomalies with lower change frequencies in the Bouguer gravity anomalies are eliminated, and the remaining high-frequency anomalies with higher change frequency are regarded as the local gravity anomalies.

Further, the obtained local gravity anomalies are divided at multiple scales, i.e., according to different change frequencies, to obtain the local gravity anomalies corresponding to a plurality of change frequency intervals. The local gravity anomaly that matches the possible change frequency region of the predicted local gravity anomaly of the target body is taken as the local gravity anomaly of the target body, and the density inversion is performed according to the local gravity anomaly of the target body to obtain the density of the target body.

In the above process, the high-frequency anomalies in the Bouguer gravity anomaly are directly taken as local gravity anomalies. However, high-frequency anomalies are not necessarily local gravity anomalies, so the local gravity anomalies obtained through the above process are inaccurate. Meanwhile, obtaining the local gravity anomaly of the target body through multi-scale division depends on whether the density prediction model can accurately predict the target body, and it is often difficult for the density prediction model to accurately predict the target body. Therefore, the local gravity anomaly of the target body obtained by the related art is inaccurate, and consequently the density distribution of the target body obtained by performing density inversion on the local gravity anomaly of the target body is also inaccurate.

In order to solve the problem of inaccurate density distribution of the target body obtained by performing density inversion in the related art, embodiments of the present application provide a density determination method comprising steps of:
acquiring Bouguer gravity anomalies at a plurality of measurement points set for a target body to be measured, wherein the target body to be measured is a geological body at a specified depth, and a distance between adjacent measurement points among the plurality of measurement points and the specified depth satisfy a preset condition;
determining, for each measurement point, a Bouguer gravity anomaly of the target body to be measured at the measurement point as a first anomaly at the measurement point, based on the Bouguer gravity anomalies at the plurality of measurement points, and determining a Bouguer gravity anomaly of a reference body corresponding to the target body to be measured at the measurement point as a second anomaly at the measurement point, based on the Bouguer gravity anomalies at the plurality of measurement points, wherein the reference body is a geological body with a depth greater than the specified depth;
calculating, for each measurement point, a difference between the first anomaly and the second anomaly at the measurement point as a local gravity anomaly of the target body to be measured at the measurement point; and
performing, based on the local gravity anomaly of the target body to be measured at each measurement point, density inversion on the target body to be measured to obtain a density distribution in a transverse cross-section of the target body to be measured.

According to the technical solutions of the embodiments discussed above, since the Bouguer gravity anomaly of the target body to be measured is formed by superimposing the local gravity anomaly of the target body to be measured and the Bouguer gravity anomaly at a deeper location, and the Bouguer gravity anomaly at the deeper location is equivalent to the Bouguer gravity anomaly of the reference body, an accurate local gravity anomaly of the target body to be measured can be obtained by calculating the difference between the first anomaly and the second anomaly. Therefore, by performing density inversion on the target body to be measured based on the local gravity anomaly of the target body to be measured, an accurate density distribution of the target body to be measured can be obtained. It can be seen that compared with the related art, the present solution can obtain the density of the target body more accurately.

It should be noted that the embodiments of the present application can be applied to various types of electronic devices, such as personal computers, servers, smart terminals, and other devices with data processing capabilities. Moreover, the density determination method provided by the embodiments of the present application may be realized by means of software, hardware, or a combination thereof.

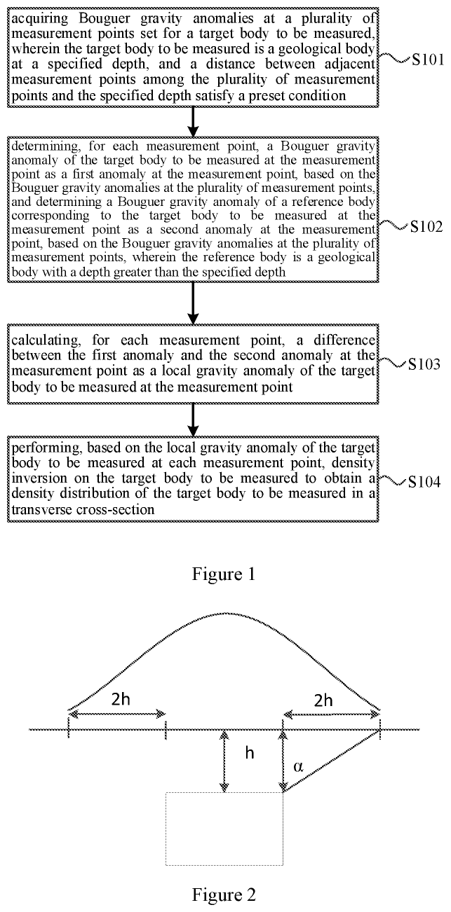

As shown in FIG. 1, the density determination method provided by embodiments of the present application includes the following steps:

In S101, Bouguer gravity anomalies are acquired at a plurality of measurement points set for a target body to be measured, wherein the target body to be measured is a geological body at a specified depth, and a distance (first distance) between adjacent measurement points among the plurality of measurement points and the specified depth satisfy a preset condition.

The target body to be measured is the geological body at the specified depth, which can be understood as the underground three-dimensional region. For example, when it is necessary to measure the density distribution in a three-dimensional region that starts at a specified depth of 500 m underground and extends downwards with a length of 100 m, a width of 50 m, and a height of 50 m, the underground three-dimensional region can be regarded as the target body to be measured, and the specified depth is the burial depth of the target body.

In order to improve the accuracy of the density obtained through the inversion, before acquiring the Bouguer gravity anomaly, it is necessary to determine the measurement region for measuring the gravity magnitude of the target body to be measured, and the distribution positions of the measurement points in the measurement region. In other words, the coordinates of the measurement points, the measurement distance (i.e., the distance between adjacent measurement points), and the boundary of the measurement region should be determined before acquiring the Bouguer gravity anomaly.

In order to clearly describe the technical solution of the embodiment, the definition of field width proposed by the inventors of this application is given.

Definition of gravity field width: The gravity field width ΔX is the horizontal distance from the point where the maximum absolute value of the basic field (unit density field) drops by 80% (about 1 dB, 10 log) to the point of absolute maximum value. The wider the spatial spread of the gravity field, the greater the field width and the smaller the cutoff frequency. The ratio of the field value Gzx of the gravity field at point x to the absolute maximum value Gz0 of the gravity field is:

$$\frac{{G}_{zx}}{{G}_{z 0}} = {cos}^{3} ( α )$$

From this formula, it is clear that when the ratio is 0.8, α is approximately 21.83°.

FIG. 2 shows a schematic diagram of a boundary of a measurement region set for a target body to be measured of an embodiment of the present application. The rectangular region in FIG. 2 is the target body to be measured, and h is the specified depth of the target body to be measured. The boundary of the measurement region may start at a boundary of a ground region corresponding to the target body to be measured, and the boundary of the measurement region is greater than or equal to twice the specified depth. If there is a plurality of target bodies, the boundary of the measurement region is greater than or equal to twice the maximum specified depth.

In this embodiment, the distance between adjacent measurement points and the specified depth of the target body to be measured satisfy a preset condition.

Optionally, in one implementation, the distance between adjacent measurement points in the above plurality of measurement points and the specified depth satisfy the preset condition:

$$Δ X \leq \frac{h}{a}$$

where ΔX is the distance between adjacent measurement points, also known as the measurement distance, h is the specified depth, and a is a preset parameter.

Optionally, in order to make the measured gravity data recoverable, the a may be 2.5, i.e., the measurement distance is less than or equal to one 2.5^{th} of the specified depth, that is:

$$Δ X \leq \frac{h}{2.5}$$

According to the definition of the field width of the gravity field, when measuring with the field width, it can be ensured that at least one point near the maximum gravity field value (i.e., the maximum absolute value) (within the range of amplitude variation from 1 to 94.2%) is measured, thus ensuring that the shape distortion of the measured gravity field curve will not be too large, or in other words, the anomaly with a depth equal to or greater than 2.5 times the measurement distance can be well recorded in the measured gravity data.

Secondly, the cutoff frequency change of the anomaly with a depth greater than or equal to 2.5 times of the measurement distance is moderate. If the field width is used as the measurement distance, the amplitude at the cutoff frequency is about 28.7% of the maximum amplitude, with a slight loss of high frequencies. If 2 times the field width is used as the measurement distance, the amplitude at the cutoff frequency is about 53.5% of the maximum amplitude, with a severe loss of medium and high frequencies. If ½ of the field width is used as the measurement distance, the amplitude at the cutoff frequency is about 8.2% of the maximum amplitude, with almost no loss. Therefore, if the measurement distance is less than the field width, the measurement points are too dense, and if the measurement distance is greater than the field width, the measurement points are too sparse. Thus, the measurement spacing is optimal near the field width.

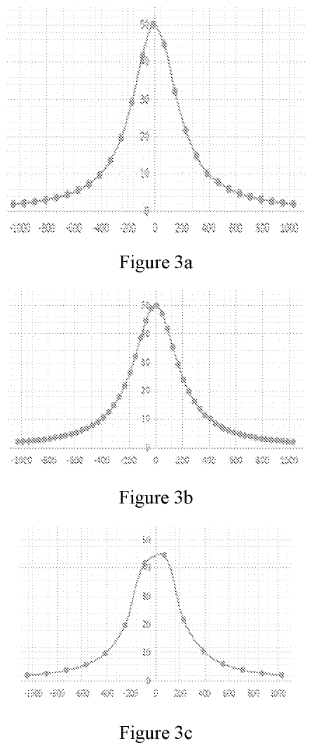

For example, FIGS. 3a-3c are the Bouguer gravity anomaly diagrams obtained by measuring a cylinder with a specified depth of 200 meters, a radius of 10 meters, and extending downwards infinitely from a depth of 200 meters to the underground using different measurement distances. The unit of the horizontal coordinate in the figures is meter, and of the vertical coordinate is microgal (μgal). When the measurement distance is less than or equal to 80 meters, it meets the condition that the measurement distance is less than or equal to one 2.5^{th} ( 1/2.5) of the specified depth. Among them, FIG. 3a is a Bouguer gravity anomaly diagram obtained by measuring at a measurement distance of 80 meters, FIG. 3b is a Bouguer gravity anomaly diagram obtained by measuring at a measurement distance of 40 meters, and FIG. 3c is a Bouguer gravity anomaly diagram obtained by measuring at a measurement distance of 160 meters. It can be seen that the Bouguer gravity anomaly in FIG. 3c is severely distorted, the Bouguer gravity anomaly in FIG. 3a is slightly distorted, and the Bouguer gravity anomaly in FIG. 3b is almost distortion-free, but the measurement points are too dense.

In S102, for each measurement point, a Bouguer gravity anomaly of the target body to be measured at the measurement point is determined as a first anomaly at the measurement point, based on the Bouguer gravity anomalies at the plurality of measurement points, and a Bouguer gravity anomaly of a reference body corresponding to the target body to be measured at the measurement point is determined as a second anomaly at the measurement point, based on the Bouguer gravity anomalies at the plurality of measurement points, wherein the reference body is a geological body with a depth greater than the specified depth.

In this case, for the gravity field generated by any geological body, the shallower the geological body, the smaller the field width of the gravity field generated by the geologic body, and the greater the change in the field value of the gravity field measured at adjacent points. The deeper the geological body, the larger the field width of the gravity field generated by the geological body, and the smaller the change in the field value of the gravity field measured at adjacent points.

The expression obtained by expanding the gravity field into a Taylor series is:

$$g = ρ ⊗ {G}_{0} + ρ ⊗ {G}_{1} + ρ ⊗ {G}_{2} + ρ ⊗ {G}_{3} + …$$

where g is the gravity field, Gᵢ denotes the part of the i-th derivative term in the Green's function series expansion, and ρ is the density.

Sampling at a single measurement distance is conducted, and in the field value measured at twice the measurement distance, the absolute maximum value of the ratio of the third derivative term to the total field value is about 1.24%, the absolute maximum value of the ratio of the fourth derivative term to the total field value is about 0.2%, and the higher-order derivative terms can be ignored. That is, when sampling with a single measurement distance, the field value of the gravity field with a field width greater than or equal to twice the measurement distance can be expressed by a low-order polynomial at adjacent points and is recursive, that is, the recursive expression of the gravity field is:

$${g}_{r n} ( x , y ) = {g}_{ln} ( x , y ) + {g}_{r ( n + 1 )} ( x , y )$$

where gᵣₙ(x, y) is the Bouguer gravity anomaly obtained when measuring with 2ⁿ times of the measurement distance, gₗₙ(x, y) is the local gravity anomaly obtained when measuring with 2ⁿ times of the measurement distance, and gᵣ₍ₙ₊₁₎(x, y) is the Bouguer gravity anomaly obtained when measuring with 2ⁿ⁺¹ times of the measurement distance.

The transform formula can be obtained:

$${g}_{ln} ( x , y ) = {g}_{r n} ( x , y ) - {g}_{r ( n + 1 )} ( x , y )$$

That is, it can be considered that the Bouguer gravity anomaly data(h) of the target body at a shallower depth is a superposition of the local gravity anomaly local(h) at this depth and the Bouguer gravity anomaly data(h+Δh) of the geological body at a deeper depth, that is:

$$data ( h ) = local ( h ) + data ( h + Δ h )$$

The transform formula can be obtained:

$$local ( h ) = data ( h ) - data ( h + Δ h )$$

where h is the depth of the target body at the shallower depth, h+Δh is the depth of the geological body at the deeper depth, and Δh is the difference in depth between the geological body at the deeper depth and the target body at the shallower depth.

Based on the above principle, the present embodiment takes the Bouguer gravity anomaly of the target body to be measured as the first anomaly at the measurement point, corresponding to gᵣₙ(x, y) or data(h) in the above formula, and takes the Bouguer gravity anomaly of a reference body with a depth equal to the sum of the specified depth and the distance between adjacent measurement points as the second anomaly at the measurement point, corresponding to gᵣ₍ₙ₊₁₎(x, y) or data(h+Δh) in the above formula.

In S103, for each measurement point, a difference between the first anomaly and the second anomaly at the measurement point is calculated as a local gravity anomaly of the target body to be measured at the measurement point.

According to the above description, it can be known that the difference between the first anomaly and the second anomaly is the local gravity anomaly of the target body to be measured at the measurement point. An accurate local gravity anomaly of the target body to be measured can be obtained by the present embodiment.

In S104, performing density inversion on the target body to be measured based on the local gravity anomaly of the target body to be measured at each measurement point, to obtain a density distribution of the target body to be measured in a transverse cross-section.

The formula for the local gravity anomaly is:

$$data ( x , y , z ) = M \int \int \int \frac{σ ( ξ , η , ζ ) ( ζ - z ) d ξ d η d ζ}{{[ {( x - ξ )}^{2} + {( y - η )}^{2} + {( z - ζ )}^{2} ]}^{3 / 2}}$$

where data(x, y, z) denotes the local gravity anomaly of the target body at the measurement point (x, y, z), which is located on the ground when z=0, σ (ξ, η, ζ) denotes the density at the underground point (ξ, η, ζ), and M represents the gravity constant.

By substituting the local gravity anomaly of the target body to be measured at each measurement point into the above local gravity anomaly formula, the volume inversion of the target body to be measured can be performed. The volume inversion, however, is to invert the density values of the three-dimensional points within Nz*Nx*Ny target bodies through the known local gravity anomalies at Nx*Ny measurement points. This is an underdetermined problem that makes it impossible to obtain accurate density values for each three-dimensional point within the target body through volume inversion.

For this reason, in the present embodiment, when performing the density inversion on the target body to be measured, it is assumed that the density σ (x,y,h) at any point within the target body does not change with depth near h, so that it is sufficient to obtain only the density distribution in the transverse cross-section, and the obtained density distribution in the transverse cross-section of the target body is accurate. On this basis, in one implementation, the above S104 includes:
substituting the local gravity anomaly of the target body to be measured at each measurement point into a layer density inversion formula to obtain the density distribution of the target body to be measured in the transverse cross-section. The layer density inversion formula is a transform formula of a density inversion formula in the case of a constant density in a longitudinal cross-section of the target body to be measured.

In this case, the density of the target body to be measured in the longitudinal cross-section is constant, that is, the density σ (x,y,h) at any point within the target body does not change with depth near h. At this point, the above local gravity anomaly formula is:

$$data ( x , y , h ) = \int \int σ ( ξ , η , h ) G ( x - ξ , y - η , h ) Δ hd ξ d η$$

By substituting the local gravity anomaly of the target body to be measured at each measurement point into the layer density inversion formula, the density distribution of the target body to be measured in the transverse cross-section can be obtained.

According to the embodiments discussed above, since the Bouguer gravity anomaly of the target body to be measured is formed by superimposing the local gravity anomaly of the target body to be measured and the Bouguer gravity anomaly at a deeper location, and the Bouguer gravity anomaly at the deeper location is equivalent to the Bouguer gravity anomaly of the reference body, an accurate local gravity anomaly of the target body to be measured can be obtained by calculating the difference between the first anomaly and the second anomaly. Therefore, by performing density inversion on the target body to be measured based on the local gravity anomaly of the target body to be measured, an accurate density distribution of the target body to be measured can be obtained. It can be seen that compared with the related art, the present solution can obtain the density of the target body more accurately.

Optionally, in another embodiment of the present application, in the step S102, determining a Bouguer gravity anomaly of the target body to be measured at the measurement point as a first anomaly at the measurement point based on the Bouguer gravity anomalies at the plurality of measurement points can be implemented through the following steps:

Step 1: determining a first target region corresponding to the measurement point. The first target region is a region centered on the measurement point and containing a first preset number of first measurement points. The first measurement points are measurement points other than the measurement point.

First, the first target region may be determined for each measurement point. The first target region is a region centered on the measurement point and comprising a first preset number of first measurement points. The first measurement points are measurement points other than the measurement point.

It should be noted that the first target region is only equivalent to a local region of the first measurement point because the distance between adjacent measurement points in the first measurement points and the specified depth of the target body satisfy a preset condition, i.e., the distance between adjacent measurement points is equal to one 2.5^{th} ( 1/2.5) of the specified depth. The Bouguer gravity anomaly of the target body at the measurement point may be regarded in the first target region as an N-order surface associated with the coordinate values and the Bouguer gravity anomaly at the measurement point.

The above first preset quantity may be determined based on experience and actual scenarios.

Step 2: determining the Bouguer gravity anomaly of the target body to be measured at the measurement point as the first anomaly at the measurement point using a best approximation, based on Bouguer gravity anomalies at the first measurement points within the first target region.

By performing the best approximation of the polynomial point-by-point, the Bouguer gravity anomaly of the target body to be measured at the measurement point can be obtained more accurately.

In one implementation, the above step 2 optionally includes:
obtaining a fitted surface function as a Bouguer gravity anomaly function of the target body to be measured at the measurement point by using surface fitting to perform the best approximation, based on the Bouguer gravity anomaly at each of the first measurement points and coordinates of each of the first measurement points within the first target region; and
substituting the coordinates of the measurement point into the Bouguer gravity anomaly function of the target body to be measured to obtain the Bouguer gravity anomaly of the target body to be measured at the measurement point as the first anomaly at the measurement point.

According to the embodiments discussed above, since the Bouguer gravity anomaly of the target body to be measured is formed by superimposing the local gravity anomaly of the target body to be measured and the Bouguer gravity anomaly at a deeper location, and the Bouguer gravity anomaly at the deeper location is equivalent to the Bouguer gravity anomaly of the reference body, an accurate local gravity anomaly of the target body to be measured can be obtained by calculating the difference between the first anomaly and the second anomaly. Therefore, by performing density inversion on the target body to be measured based on the local gravity anomaly of the target body to be measured, an accurate density distribution of the target body to be measured can be obtained. It can be seen that compared with the related art, the present solution can obtain the density of the target body more accurately.

Optionally, in another embodiment of the present application, in the step S102, determining a Bouguer gravity anomaly of a reference body corresponding to the target body to be measured at the measurement point as a second anomaly at the measurement point based on the Bouguer gravity anomalies at the plurality of measurement points can be implemented through the following steps:

Step 1: determining a second target region corresponding to the measurement point. The second target region is a region centered on the measurement point and containing a second preset number of second measurement points. A distance between the second measurement point and the measurement point is greater than or equal to twice the first distance, and a distance between adjacent second measurement points is twice the first distance; and

Step 2: determining the Bouguer gravity anomaly of the reference body corresponding to the target body to be measured at the measurement point as the second anomaly at the measurement point by using a best approximation based on Bouguer gravity anomalies at the second measurement points within the second target region.

In one implementation, step 2 optionally includes:
obtaining a fitted surface function as a Bouguer gravity anomaly function of the reference body corresponding to the target body to be measured at the measurement point by using surface fitting to perform the best approximation, based on the Bouguer gravity anomaly at each of the second measurement points and coordinates of each of the second measurement points within the second target region; and
substituting the coordinates of the measurement point into the Bouguer gravity anomaly function of the reference body to obtain the Bouguer gravity anomaly of the reference body at the measurement point as the second anomaly at the measurement point.

The above implementation is the same as or similar to the determination of the first anomaly and will not be repeated herein.

In the embodiments discussed above, since the Bouguer gravity anomaly of the target body to be measured is formed by superimposing the local gravity anomaly of the target body to be measured and the Bouguer gravity anomaly at a deeper location, and the Bouguer gravity anomaly at the deeper location is equivalent to the Bouguer gravity anomaly of the reference body, an accurate local gravity anomaly of the target body to be measured can be obtained by calculating the difference between the first anomaly and the second anomaly. Therefore, by performing density inversion on the target body to be measured based on the local gravity anomaly of the target body to be measured, an accurate density distribution of the target body to be measured can be obtained. It can be seen that compared with the related art, the present solution can obtain the density of the target body more accurately.

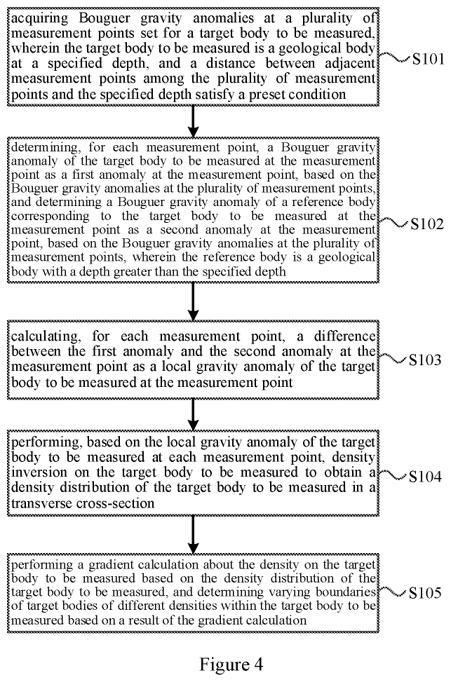

Based on the embodiment of FIG. 1, as shown in FIG. 4, a density determination method provided by another embodiment of the present application further comprising after S104:

In S105, performing a gradient calculation about the density on the target body to be measured based on the density distribution of the target body to be measured, and determining varying boundaries of target bodies of different densities within the target body to be measured based on a result of the gradient calculation.

In order to further analyze the different geological bodies contained within the target body to be measured, the density distribution boundary of the target body to be measured can be further divided to obtain the boundaries of the geological bodies of different densities within the target body to be measured.

Optionally, the gradient in the transverse plane at each point within the target body to be measured may be calculated to determine the boundaries of the geological bodies of different densities within the target body to be measured.

The formula for obtaining the gradient is known to those skilled in the art as:

$$grad ( f ) = [ \begin{matrix}\frac{df}{dx} \\ \frac{df}{dy}\end{matrix} ]$$

where grad(f) denotes the gradient of the binary function z=f(x, y) at the point

$$( x , y ) , \frac{df}{dx}$$

is the partial derivative in the X-axis direction, and

$$\frac{df}{dy}$$

is the partial derivative in the Y-axis direction.

The gradient value at each point (x, y) is:

$$\vert gra d ( f ) \vert = \sqrt{{( \frac{df}{dx} )}^{2} + {( \frac{df}{dy} )}^{2}}$$

In this case, the transverse template for the horizontal boundary in the transverse plane may optionally be:

$${G}_{x} = [ \begin{matrix}- 1 & 0 & 1 \\ - 1 & 0 & 1 \\ - 1 & 0 & 1\end{matrix} ]$$

The horizontal template for the longitudinal boundary in the transverse plane may optionally be:

$${G}_{y} = [ \begin{matrix}1 & 1 & 1 \\ 0 & 0 & 0 \\ - 1 & - 1 & - 1\end{matrix} ]$$

By substituting each point (x, y) within the target to be measured into the above formula, the gradient value of the point in the four directions is obtained. It should be noted that the above is only an example of calculating the gradient value of each point in four directions. In practice, the gradient template can be selected according to the needs to calculate gradient values in multiple directions, such as calculating the gradient value of each point in eight directions.

In the embodiments discussed above, since the Bouguer gravity anomaly of the target body to be measured is formed by superimposing the local gravity anomaly of the target body to be measured and the Bouguer gravity anomaly at a deeper location, and the Bouguer gravity anomaly at the deeper location is equivalent to the Bouguer gravity anomaly of the reference body, an accurate local gravity anomaly of the target body to be measured can be obtained by calculating the difference between the first anomaly and the second anomaly. Therefore, by performing density inversion on the target body to be measured based on the local gravity anomaly of the target body to be measured, an accurate density distribution of the target body to be measured can be obtained. It can be seen that compared with the related art, the present solution can obtain the density of the target body more accurately.

Corresponding to the method provided in the above embodiments, as shown in FIG. 5, embodiments of the present application also provide a density determination apparatus comprising:
a Bouguer gravity anomaly acquisition module 501 configured to acquire Bouguer gravity anomalies at a plurality of measurement points set for a target body to be measured. The target body to be measured is a geological body at a specified depth, and a distance (first distance) between adjacent measurement points among the plurality of measurement points and the specified depth satisfy a preset condition;
a regional gravity anomaly acquisition module 502 configured to determine, for each measurement point, a Bouguer gravity anomaly of the target body to be measured at the measurement point as a first anomaly at the measurement point, based on the Bouguer gravity anomalies at the plurality of measurement points, and determine a Bouguer gravity anomaly of a reference body corresponding to the target body to be measured at the measurement point as a second anomaly at the measurement point, based on the Bouguer gravity anomalies at the plurality of measurement points. The reference body is a geological body with a depth greater than the specified depth;
a local gravity anomaly determination module 503 configured to calculate, for each measurement point, a difference between the first anomaly and the second anomaly at the measurement point as a local gravity anomaly of the target body to be measured at the measurement point; and
a density inversion module 504 configured to perform density inversion on the target body to be measured based on the local gravity anomaly of the target body to be measured at each measurement point to obtain a density distribution in a transverse cross-section of the target body to be measured.

In an embodiment, the regional gravity anomaly acquisition module includes:
a first region determination sub-module configured to determine a first target region corresponding to the measurement point, wherein the first target region is a region centered on the measurement point and containing a first preset number of first measurement points, which are measurement points other than the measurement point; and
a first anomaly determination sub-module configured to determine the Bouguer gravity anomaly of the target body to be measured at the measurement point as the first anomaly at the measurement point using a best approximation, based on Bouguer gravity anomalies at the first measurement points within the first target region.

In an embodiment, the first anomaly determination sub-module is configured to obtain a fitted surface function as a Bouguer gravity anomaly function of the target body to be measured at the measurement point using surface fitting to perform the best approximation, based on the Bouguer gravity anomaly at each of the first measurement points and coordinates of each of the first measurement points within the first target region; and to substitute the coordinates of the measurement point into the Bouguer gravity anomaly function of the target body to be measured to obtain the Bouguer gravity anomaly of the target body to be measured at the measurement point as the first anomaly at the measurement point.

In an embodiment, the regional gravity anomaly acquisition module includes:
a second region determination sub-module configured to determine a second target region corresponding to the measurement point, wherein the second target region is a region centered on the measurement point and containing a second preset number of second measurement points, a distance between the second measurement point and the measurement point is greater than or equal to twice the first distance, and a distance between adjacent second measurement points is twice the first distance;
and a second anomaly determination sub-module configured to determine the Bouguer gravity anomaly of the reference body corresponding to the target body to be measured at the measurement point as the second anomaly at the measurement point by using a best approximation based on Bouguer gravity anomalies at the second measurement points within the second target region.

In an embodiment, the second anomaly determination sub-module is configured to obtain a fitted surface function as a Bouguer gravity anomaly function of the reference body corresponding to the target body to be measured at the measurement point by using surface fitting to perform the best approximation based on the Bouguer gravity anomaly at each of the second measurement points and coordinates of each of the second measurement points within the second target region; and to substitute the coordinates of the measurement point into the Bouguer gravity anomaly function of the reference body to obtain the Bouguer gravity anomaly of the reference body at the measurement point as the second anomaly at the measurement point.

In an embodiment, the preset condition is:

$$Δ X \leq \frac{h}{a}$$

where ΔX is the distance, h is the specified depth, and a is a preset parameter.

In an embodiment, the density inversion module is configured to substitute the local gravity anomaly of the target body to be measured at each measurement point into a layer density inversion formula to obtain the density distribution of the target body to be measured in the transverse cross-section. The layer density inversion formula is a transform formula of a density inversion formula in the case of a constant density of the target body to be measured in a longitudinal cross-section.

In an embodiment, the apparatus may further include:
a boundary determination module configured to perform a gradient calculation about the density on the target body to be measured based on the density distribution of the target body to be measured, and to determine varying boundaries of target bodies of different densities within the target body to be measured based on a result of the gradient calculation.

In the embodiments discussed above, since the Bouguer gravity anomaly of the target body to be measured is formed by superimposing the local gravity anomaly of the target body to be measured and the Bouguer gravity anomaly at a deeper location, and the Bouguer gravity anomaly at the deeper location is equivalent to the Bouguer gravity anomaly of the reference body, an accurate local gravity anomaly of the target body to be measured can be obtained by calculating the difference between the first anomaly and the second anomaly. Therefore, by performing density inversion on the target body to be measured based on the local gravity anomaly of the target body to be measured, an accurate density distribution of the target body to be measured can be obtained. It can be seen that compared with the related art, the present solution can obtain the density of the target body more accurately.

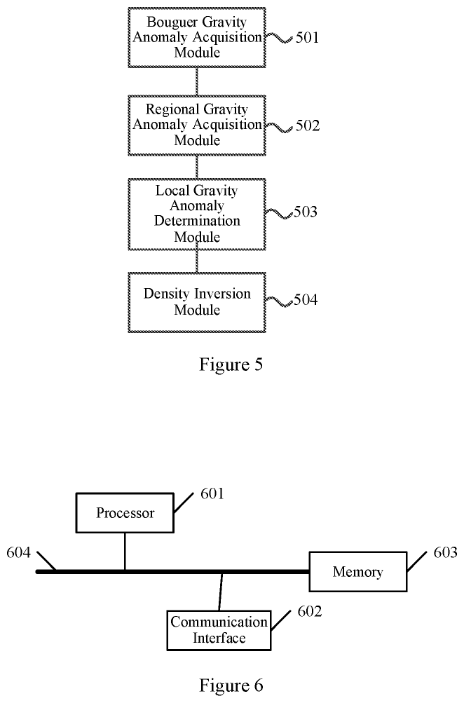

Embodiments of the present application further provide an electronic device, as shown in FIG. 6, comprising a processor 601, a communication interface 602, a memory 603, and a communication bus 604. The processor 601, the communication interface 602, and the memory 603 are in communication with each other via the communication bus 604.

Memory 603 is configured for storing a computer program. The processor 601 is configured for executing the program in memory 603 to implement the steps of the density determination method provided in the above embodiments.

The above communication bus can be a peripheral component interconnection standard (PCI) bus or extended industry standard architecture (EISA) bus, etc., and can be categorized as address bus, data bus, control bus, etc. It is indicated in the figure with only one thick line, but this does not imply that there is only one bus or one type of bus.

The communication interface is configured for communication between the above electronic devices and other devices.

The memory may include random access memory (RAM) or may include non-volatile memory (NVM), such as at least one disk storage. Optionally, the memory may also be at least one storage device located away from the processor.

The processor may be a general-purpose processor, including a central processor unit (CPU), a network processor (NP), and the like; it may also be a digital signal processor (DSP), an application-specific integrated circuit (ASIC), a field-programmable gate array (FPGA) or other programmable logic device, a discrete gate or transistor logic device, and a discrete hardware component.

In yet another embodiment of the present application, there is further provided a computer-readable storage medium which internally stores a computer program, and when the computer program is executed by a processor, any of the above-described density determination methods is implemented.

In yet another embodiment of the present application, there is also provided a computer program product comprising instructions that when run on a computer cause the computer to perform any of the density determination methods of the above embodiments.

The above embodiments may be implemented in whole or in part by software, hardware, firmware, or any combination thereof. When implemented using software, the embodiments may be implemented in whole or in part in the form of a computer program product. The computer program product comprises one or more computer instructions. Loading and executing the computer program instructions on a computer will generate, in whole or in part, a process or function in accordance with the embodiments of the present application. The computer may be a general purpose computer, a specialized computer, a computer network, or other programmable device. The computer instructions may be stored in a computer-readable storage medium or transmitted from one computer-readable storage medium to another computer-readable storage medium. For example, computer instructions may be transmitted by wired (e.g., coaxial cable, fiber optic, digital subscriber line (DSL)) or wireless (e.g., infrared, wireless, microwave, etc.) means from one website site, computer, server, or data center to another website site, computer, server or data center. The computer-readable storage medium may be any usable medium to which a computer can access or a data storage device such as a server, data center, etc., containing one or more usable medium being integrated. The usable medium may be a magnetic medium, (e.g., floppy disk, hard disk, tape), an optical medium (e.g., DVD), or a semiconductor medium (e.g., solid state disk Solid State Disk (SSD)), and the like.

It should be noted that in this disclosure, relation terms such as “first” and “second” are used only to distinguish one entity or operation from another, and do not necessarily require or imply the existence of any such actual relationship or order between these entities or operations. Furthermore, the terms “including”, “comprising”, or any other variant thereof, are intended to cover non-exclusive inclusion, such that a process, method, article, or apparatus comprising a set of elements includes not only those elements, but also other elements not expressly listed, or further includes elements essential to such a process, method, article or equipment. In the absence of further limitation, the fact that an element is defined by the phrase “including a . . . ” does not exclude the existence of other identical element in the process, method, article, or apparatus that includes said element.

Each of the embodiments in this specification is described in a related manner, and it is sufficient to refer to each embodiment for the similarities between the embodiments, and each embodiment focuses on the differences from the other embodiments. In particular, for the device, apparatus, and system embodiments, since they basically share similar concept to the method embodiments, the descriptions thereof are relatively simple, and it is sufficient to refer to part of the description of the method embodiments for the relevant parts.

The above mentioned are only the preferred embodiments of the present application and are not intended to limit the present application. Any modifications, equivalent substitutions, improvements, etc., made within the spirit and principles of the present application should be included in the scope of protection of the present application.

1. A density determination method comprising steps of:
acquiring Bouguer gravity anomalies at a plurality of measurement points set for a target body to be measured, wherein the target body to be measured is a geological body at a specified depth, and a first distance between adjacent measurement points among the plurality of measurement points and the specified depth satisfy a preset condition;
determining, for each measurement point, a Bouguer gravity anomaly of the target body to be measured at the measurement point as a first anomaly at the measurement point, based on the Bouguer gravity anomalies at the plurality of measurement points, and determining a Bouguer gravity anomaly of a reference body corresponding to the target body to be measured at the measurement point as a second anomaly at the measurement point, based on the Bouguer gravity anomalies at the plurality of measurement points, wherein the reference body is a geological body with a depth greater than the specified depth;
calculating, for each measurement point, a difference between the first anomaly and the second anomaly at the measurement point as a local gravity anomaly of the target body to be measured at the measurement point; and
performing, based on the local gravity anomaly of the target body to be measured at each measurement point, density inversion on the target body to be measured to obtain a density distribution of the target body to be measured in a transverse cross-section as the density of the target body to be measured.

2. The method according to claim 1, wherein the step of determining a Bouguer gravity anomaly of the target body to be measured at the measurement point as a first anomaly at the measurement point based on the Bouguer gravity anomalies at the plurality of measurement points comprises:
determining a first target region corresponding to the measurement point, wherein the first target region is a region centered on the measurement point and containing a first preset number of first measurement points which are measurement points other than the measurement point; and
determining the Bouguer gravity anomaly of the target body to be measured at the measurement point as the first anomaly at the measurement point using a best approximation, based on Bouguer gravity anomalies at the first measurement points within the first target region.

3. The method according to claim 2, wherein the step of determining the Bouguer gravity anomaly of the target body to be measured at the measurement point as the first anomaly at the measurement point using a best approximation based on Bouguer gravity anomalies at the first measurement points within the first target region comprises:
obtaining a fitted surface function as a Bouguer gravity anomaly function of the target body to be measured at the measurement point using surface fitting to perform the best approximation, based on the Bouguer gravity anomaly at each of the first measurement points and coordinates of each of the first measurement points within the first target region; and
substituting the coordinates of the measurement point into the Bouguer gravity anomaly function of the target body to be measured to obtain the Bouguer gravity anomaly of the target body to be measured at the measurement point as the first anomaly at the measurement point.

4. The method according to claim 1, wherein the step of determining a Bouguer gravity anomaly of a reference body corresponding to the target body to be measured at the measurement point as a second anomaly at the measurement point based on the Bouguer gravity anomalies at the plurality of measurement points comprises:
determining a second target region corresponding to the measurement point, wherein the second target region is a region centered on the measurement point and containing a second preset number of second measurement points, a distance between the second measurement point and the measurement point is greater than or equal to twice the first distance, and a distance between adjacent second measurement points is twice the first distance; and
determining the Bouguer gravity anomaly of the reference body corresponding to the target body to be measured at the measurement point as the second anomaly at the measurement point using a best approximation, based on Bouguer gravity anomalies at the second measurement points within the second target region.

5. The method according to claim 4, wherein the step of determining the Bouguer gravity anomaly of the reference body corresponding to the target body to be measured at the measurement point as the second anomaly at the measurement point using a best approximation based on Bouguer gravity anomalies at the second measurement points within the second target region comprises:
obtaining a fitted surface function as a Bouguer gravity anomaly function of the reference body corresponding to the target body to be measured at the measurement point using surface fitting to perform the best approximation, based on the Bouguer gravity anomaly at each of the second measurement points and coordinates of each of the second measurement points within the second target region; and
substituting the coordinates of the measurement point into the Bouguer gravity anomaly function of the reference body to obtain the Bouguer gravity anomaly of the reference body at the measurement point as the second anomaly at the measurement point.

6. The method according to claim 1, wherein the preset condition is:
$$Δ X \leq \frac{h}{a}$$
wherein ΔX is the distance, h is the specified depth, and a is a preset parameter.

7. The method according to claim 1, wherein the step of performing, based on the local gravity anomaly of the target body to be measured at each measurement point, density inversion on the target body to be measured to obtain a density distribution in a transverse cross-section of the target body to be measured comprises:
substituting the local gravity anomaly of the target body to be measured at each measurement point into a layer density inversion formula to obtain the density distribution in the transverse cross-section of the target body to be measured,
wherein the layer density inversion formula is a transform formula of a density inversion formula in the case of a constant density in a longitudinal cross-section of the target body to be measured.

8. The method according to claim 1, further comprising a step of:
performing a gradient calculation about the density on the target body to be measured based on the density distribution of the target body to be measured, and determining varying boundaries of target bodies of different densities within the target body to be measured based on a result of the gradient calculation.

9. A density determination apparatus comprising:
a Bouguer gravity anomaly acquisition module configured to acquire Bouguer gravity anomalies at a plurality of measurement points set for a target body to be measured, wherein the target body to be measured is a geological body at a specified depth, and a first distance between adjacent measurement points among the plurality of measurement points and the specified depth satisfy a preset condition;
a regional gravity anomaly acquisition module configured to determine, for each measurement point, a Bouguer gravity anomaly of the target body to be measured at the measurement point as a first anomaly at the measurement point, based on the Bouguer gravity anomalies at the plurality of measurement points, and to determine a Bouguer gravity anomaly of a reference body corresponding to the target body to be measured at the measurement point as a second anomaly at the measurement point, based on the Bouguer gravity anomalies at the plurality of measurement points, wherein the reference body is a geological body with a depth greater than the specified depth;
a local gravity anomaly determination module configured to calculate, for each measurement point, a difference between the first anomaly and the second anomaly at the measurement point as a local gravity anomaly of the target body to be measured at the measurement point; and
a density inversion module configured to perform, based on the local gravity anomaly of the target body to be measured at each measurement point, density inversion on the target body to be measured to obtain a density distribution of the target body to be measured in a transverse cross-section.

10. The apparatus according to claim 9, wherein the regional gravity anomaly acquisition module comprises:
a first region determination sub-module configured to determine a first target region corresponding to the measurement point, wherein the first target region is a region centered on the measurement point and containing a first preset number of first measurement points which are measurement points other than the measurement point; and
a first anomaly determination sub-module configured to determine the Bouguer gravity anomaly of the target body to be measured at the measurement point as the first anomaly at the measurement point using a best approximation, based on Bouguer gravity anomalies at the first measurement points within the first target region.

11. The apparatus according to claim 10, wherein the first anomaly determination sub-module is configured to obtain a fitted surface function as a Bouguer gravity anomaly function of the target body to be measured at the measurement point using surface fitting to perform the best approximation, based on the Bouguer gravity anomaly at each of the first measurement points and coordinates of each of the first measurement points within the first target region; and to substitute the coordinates of the measurement point into the Bouguer gravity anomaly function of the target body to be measured to obtain the Bouguer gravity anomaly of the target body to be measured at the measurement point as the first anomaly at the measurement point.

12. The apparatus according to claim 9, wherein the regional gravity anomaly acquisition module comprises:
a second region determination sub-module configured to determine a second target region corresponding to the measurement point, wherein the second target region is a region centered on the measurement point and containing a second preset number of second measurement points, a distance between the second measurement point and the measurement point is greater than or equal to twice the first distance, and a distance between adjacent second measurement points is twice the first distance; and
a second anomaly determination sub-module for determining the Bouguer gravity anomaly of the reference body corresponding to the target body to be measured at the measurement point as the second anomaly at the measurement point using a best approximation, based on Bouguer gravity anomalies at the second measurement points within the second target region.

13. The apparatus according to claim 12, wherein the second anomaly determination sub-module is configured to obtain a fitted surface function as a Bouguer gravity anomaly function of the reference body corresponding to the target body to be measured at the measurement point using surface fitting to perform the best approximation, based on the Bouguer gravity anomaly at each of the second measurement points and coordinates of each of the second measurement points within the second target region; and substituting the coordinates of the measurement point into the Bouguer gravity anomaly function of the reference body to obtain the Bouguer gravity anomaly of the reference body at the measurement point as the second anomaly at the measurement point.

14. The apparatus according to claim 9, wherein the preset condition is:
$$Δ X \leq \frac{h}{a}$$
wherein ΔX is the distance, h is the specified depth, and a is a preset parameter.

15. The apparatus according to claim 9, wherein the density inversion module is configured to substitute the local gravity anomaly of the target body to be measured at each measurement point into a layer density inversion formula to obtain the density distribution of the target body to be measured in the transverse cross-section, wherein the layer density inversion formula is a transform formula of a density inversion formula in the case of a constant density of the target body to be measured in a longitudinal cross-section.

16. The apparatus according to claim 9, wherein the apparatus further comprises:
a boundary determination module configured to perform a gradient calculation on the density of a target body to be measured based on the density distribution of the target body to be measured, and to determine varying boundaries of target bodies of different densities within the target body to be measured based on a result of the gradient calculation.

17. An electronic device comprising a processor, a communication interface, a memory, and a communication bus, wherein the processor, the communication interface, and the memory communicate with each other via the communication bus;
the memory is configured to store a computer program; and
the processor is configured to execute the program in the memory to implement the method of claim 1.

18. (canceled).
